(19) United States
(12) Patent Application Publication
(10) Pub. No.: US 2006/0234013 A1
(43) Pub. Date: Oct. 19, 2006

(54) Print medium exhibiting good electric conductivity and good printability

(75) Inventors: Christophe Chartier, Chambery (FR); Andree Pascal, Boulieu Les Annonay (FR)

Correspondence Address: BIRCH STEWART KOLASCH & BIRCH, PO BOX 747, FALLS CHURCH, VA, 22040-0747, US

(73) Assignee: Arjowiggins, Issy Les Moulineaux (FR)

(21) Appl. No.: 10/529,542

(22) PCT Filed: Sep. 29, 2003
(86) PCT No.: PCT/FR03/02855

§ 371 Date: Feb. 8, 2006

(30) Foreign Application Priority Data
Sep. 30, 2002 (FR) 02/12095

(51) Int. Cl. B41M 5/00

(52) U.S. Cl. 428/195.1; 428/411.1

(57) ABSTRACT

The present invention relates to a print medium covered with an electrically conductive coating, characterized in that the conductive coating comprises at least one electrically conductive synthetic pigment and at least one coating pigment having an oil-absorption capacity of greater than 80 g/100 g of pigment as measured using the United States standard ASTM Standards D2414. The invention also relates to a playing card comprising such a print medium.

The invention relates to a novel print medium having both good electrical conductivity and good printability.

A current trend in the field of print media, in particular playing cards, is the possibility of recording information on these media using both a conventional printing technique and a technique for writing data which can be detected by an appropriate reading means.

Until now, printed information was capable of being detected and recorded using optoelectronic devices which were subsequently required to transmit it to a computer for storage thereof and optional processing thereof.

In methods of this type, no addition of information is then envisaged between the printed information and that recorded.

Furthermore, there exist methods of recording information based on the application of magnetic inks to recording media, such as bank cards, for example.

In this case, the information transmitted is only readable using appropriate reading devices and cannot in principle be recognized by optical means.

The invention is thus targeted at providing a printed medium comprising printed information, which information is capable of also being detected other than by strictly optical devices.

In this context, patent FR 2 370 323 has already provided for the recording of information on a medium using conductive ink and for the reading of the information thus printed using a corona generator sensitive to the differences in conductivity in the medium.

The disadvantage in this technique is the absence of direct measurement of electrical conductivity, which can result in not insignificant losses of information, in particular in the case where the medium is intended to transmit precise identification or verification information.

In addition, this prior art was not concerned either in detail in the choice of a conductive pigment capable of conferring good electrical conductivity on the inked parts.

In the context of the invention, the Applicant has thus endeavored, first, to provide a device for reading the electrical conductivity which makes possible a simple and direct measurement which can be transmitted to a computer and, secondly, to improve the electrical conductivity of a coating applied to an information medium by choosing an appropriate conductive pigment.

The first point has formed the subject of a preliminary study by ARJO WIGGINS FINE PAPERS Ltd, linked contractually to the Applicant, which has resulted in the filing of the international patent application WO/GB-02/02631.

In this patent application, mention is made of an information medium on which has been deposited a layer of conductive pigment and an insulating varnish at the points of the conductive layer representative of the information to be stored.

The conductive layer used is a layer based on a magnesium fluorosilicate sold under the name “Laponite” by ROCKWOOD ADDITIVES Limited (UK).

This synthetic pigment resembles, both due to its structure and its chemical composition, a natural inorganic hectorite.

It results from a synthetic process, combining magnesium, lithium and sodium salts and sodium fluorosilicate, carried out under particularly strict conditions of rates and temperatures.

This produces an amorphous precipitate, which is partially crystallized after hydrothermal treatment.

The resulting product is filtered, washed, dried and milled to produce a finely divided white powder.

The silicates thus synthesized may then have the following empirical chemical formula:
Na_{0.7}⁺[(Si₈Mg_{5.5}Li_{0.3})O₂₀(OH)_{2.5}F_{1.5}]^{0.7-}

A typical chemical composition of such synthesized silicates may then be:
SiO₂=55.0%
MgO=27.0%
Li₂O=1.4%
Na₂O=3.8%
F=5.6%

Loss by calcination=6.0%

When it is added to water, the fluorosilicate powder is rapidly dispersed into primary particles.

These primary particles are comparable to disk-shaped crystals with a diameter of between 20 and 30 nm and a thickness in the region of 1 nm.

Due to its chemical structure, each fluorosilicate unit present in the crystal exhibits a charge deficiency of −0.7.

This negative charge itself occurs between the upper and lower faces of the crystal: the fluorosilicate particles are thus good conductors of electricity.

It subsequently turned out, in practice, that these fluorosilicate pigments deposited as a layer on a medium conferred a very good electrical conductivity thereon.

However, the Applicant has found that this medium covered with a conductive coating exhibited, in contrast, a low printability.

For an application essentially intended for print media, in particular for offset print media, it was therefore necessary to add a coating pigment which confers, on the final medium, good printability characteristics.

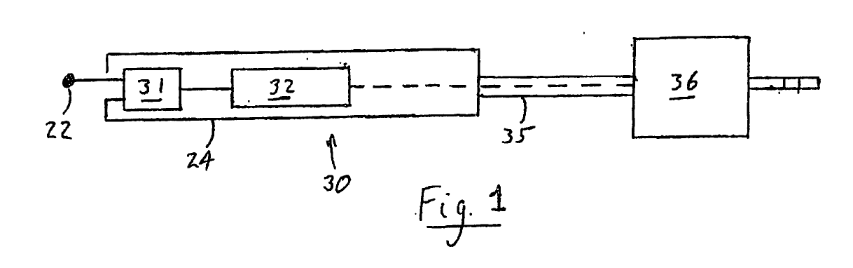

The Applicant thus carried out tests in which a coating based on calcium carbonate or on kaolin, pigments frequently used to improve the printability of printing/writing paper, and based on “Laponite” was deposited on a medium intended to be printed, the conductivity of said medium being capable of being subsequently detected using a reading device as represented in FIG. 1.

The Applicant found that it was necessary to add a large amount of pigments to obtain good printability, this being at the expense of good electrical conductivity, indeed even of acceptable electrical conductivity.

A first aim of the invention is thus targeted at providing a print medium possessing both good electrical conductivity and good printability.

The Applicant thus envisaged adding a coating pigment which confers, on the paper, a greater ink-absorption capacity than that of the conventional coating pigments, such as kaolin or calcium carbonate.

This is because problems of printability, in particular in offset, often result from poor fixing of the ink to the paper.

The fixing of the ink to the paper is generally the result of two complementary processes: the absorption of the fraction of the ink specific for conveying the color pigment, generally fine oils, and often comprising antioxidants necessary for the stability on storage, and the polymerization by oxidation of the varnishes or “harder” resins left at the surface of the paper, this fraction also comprising ink pigments.

Coated papers are particularly suitable for high-quality printing owing to the fact that the ink vehicle part is easily absorbed into the coating layer by capillary action, whereas the varnish and the pigment are left at the surface, where they have a better effect.

The varnish, in the absence of fine oil, rapidly becomes fixed in the presence of oxygen.

When the coating pigments have a low ink-absorption capacity, it may be that the vehicle part has not been completely absorbed by the paper during drying: the varnish thus has trouble becoming fixed.

An offsetting phenomenon, which corresponds to a transfer of ink from the recto of one sheet to the verso of another placed on it, thus occurs.

Certain coating pigments are thus used to increase the ink-absorption capacity of the coating.

This is the case with kaolin and calcium carbonate, which have an oil-absorption capacity of between 40 g/100 g of pigment and 75 g/100 g of pigment, as measured using the United States Standard ASTM Standards No. D2414.

The Applicant has thus favored the use of a coating pigment having an oil-absorption capacity of at least approximately 80 g/100 g of pigment.

However, a layer exhibiting a very good oil-absorption capacity can result in unsatisfactory fixing of the pigments of the layer to the surface of the paper.

This results in a dusting phenomenon during printing.

Another aim of the invention is thus to provide a print medium covered with a layer, in which medium the coating pigments confer, on the paper, a good ink-absorption capacity and limit the dusting phenomenon during printing.

Other aims and advantages of the present invention will become apparent in the description of the embodiments of the invention.

The present invention thus provides a print medium covered with an electrically conductive coating, in which medium said conductive coating comprises at least one electrically conductive synthetic pigment and at least one coating pigment having an oil-absorption capacity of greater than 80 g/100 g of pigment, as measured using the United States standard ASTM Standards D 2414.

Advantageously, the conductive synthetic pigment is a magnesium fluorosilicate.

Advantageously, the coating pigment is an amorphous silica, said silica preferably having an oil-absorption capacity of approximately 200 g/100 g of pigment, as measured using the United States standard ASTM Standards D 2414.

Specifically, the coating comprises a mixture of magnesium fluorosilicate, of amorphous silica and of calcium carbonate.

Specifically, the coating comprises a mixture of 20 to 100 parts by dry weight of magnesium fluorosilicate, of 0 to 80 parts by dry weight of calcium carbonate and of 0 to 10 parts by dry weight of amorphous silica and advantageously of 60 to 80 parts by dry weight of magnesium fluorosilicate, of 20 to 40 parts by dry weight of calcium carbonate and of 2 to 5 parts by dry weight of amorphous silica.

Advantageously, the print medium has an optical density of less than 0.8, an optical density determined using the Prüfbau print test and for a drying time of 15 seconds.

Advantageously, the print medium has a surface resistivity of less than 10¹⁰ ohms, a resistivity determined by using the United States standard ASTM D 257-99 and for a relative humidity of 10%.

Specifically, the print medium comprises information in the form of an insulating pattern deposited on the conductive coating, said insulating pattern defining, preferably, in combination with the underlying conductive coating, a bar code in which the bars have variable widths and are alternately conductive and insulating.

Specifically, the print medium comprises information read using a device sensitive to variations in the electrical conductivity and subsequently transmitted to a computer for storage thereof and optional processing thereof.

The present invention also provides a playing card comprising a print medium as defined above.

Other aims, characteristics and advantages of the present invention will become apparent in the light of the exemplary embodiments which will follow.

In all these examples, the parts, percentages and proportions are given on the basis of a dry weight, unless otherwise mentioned.

### EXAMPLES

### Comparative Example 1

A coating composition comprising a pigment of calcium carbonate type is applied, using a trailing blade coater, in a proportion of 12 g/m² to one of the faces of a sheet of base paper having a grammage of 325 g/m² sold under the reference Optima P by the Applicant Company.

The coating composition comprises:
100 parts of calcium carbonate, sold by OMYA under the reference Setacarb 80 OG,
9.3 parts of a carboxylated styrene-butadiene copolymer binder, sold by LATEXIA under the reference Rhodopas SB 083,
0.325 part of a fluorescent whitening agent, sold by BAYER PRODUITS SPÉCIAUX under the reference Blancophor PSG,
0.458 part of a poly(vinyl alcohol), sold by KURARAY under the reference Poval 104A,
0.25 part of a calcium stearate, sold by OUVRIE PMC under the reference Erol Steca 50.

### Comparative Example 2

A coating composition comprising a conductive synthetic pigment of magnesium fluorosilicate type is applied, using an air knife coater, in a proportion of 4 g/m² to one of the faces of a sheet of base paper having a grammage of 325 g/m² sold under the reference Optima P by the Applicant Company.

The coating composition comprises:
100 parts of magnesium fluorosilicate, sold by ROCKWOOD under the reference Laponite JS,
10 parts of a vinyl acetate-ethylene copolymer binder, sold by VINAMUL under the reference Vinamul 3301.

### Example 3

A coating composition comprising a conductive synthetic pigment of magnesium fluorosilicate type and a pigment of kaolin type is applied, using an air knife coater, in a proportion of 5.1 g/m² to one of the faces of a sheet of base paper having a grammage of 325 g/m² sold under the reference Optima P by the Applicant Company.

The coating composition comprises:
80 parts of magnesium fluorosilicate, sold by ROCKWOOD under the reference Laponite JS,
20 parts of a kaolin, sold by ECC International under the reference Kaolin SPS,
10 parts of a vinyl acetate-ethylene copolymer binder, sold by VINAMUL under the reference Vinamul 3252.

### Example 4

A coating composition comprising a conductive synthetic pigment of magnesium fluorosilicate type and a pigment of kaolin type is applied, using an air knife coater, in a proportion of 5 g/m² to one of the faces of a sheet of base paper having a grammage of 325 g/m² sold under the reference Optima P by the Applicant Company.

The coating composition comprises:
20 parts of magnesium fluorosilicate, sold by ROCKWOOD under the reference Laponite JS,
80 parts of a kaolin, sold by ECC International under the reference Kaolin SPS,
10 parts of a vinyl acetate-ethylene copolymer binder, sold by VINAMUL under the reference Vinamul 3252.

### Example 5

A coating composition comprising a conductive synthetic pigment of magnesium fluorosilicate type and a pigment of calcium carbonate type is applied, using an air knife coater, in a proportion of 5.2 g/m² to one of the faces of a sheet of base paper having a grammage of 325 g/m² sold under the reference Optima P by the Applicant Company.

The coating composition comprises:
80 parts of magnesium fluorosilicate, sold by ROCKWOOD under the reference Laponite JS,
20 parts of a calcium carbonate, sold by OMYA under the reference Hydrocarb 90 OG,
10 parts of a vinyl acetate-ethylene copolymer binder, sold by VINAMUL under the reference Vinamul 3252.

### Example 6

A coating composition comprising a conductive synthetic pigment of magnesium fluorosilicate type and a pigment of calcium carbonate type is applied, using an air knife coater, in a proportion of 4.9 g/m² to one of the faces of a sheet of base paper having a grammage of 325 g/m² sold under the reference Optima P by the Applicant Company.

The coating composition comprises:
20 parts of magnesium fluorosilicate, sold by ROCKWOOD under the reference Laponite JS,
80 parts of a calcium carbonate, sold by OMYA under the reference Hydrocarb 90 OG,
10 parts of a vinyl acetate-ethylene copolymer binder, sold by VINAMUL under the reference Vinamul 3252.

### Example 7

A coating composition comprising a conductive synthetic pigment of magnesium fluorosilicate type and a pigment of amorphous silica type is applied, using an air knife coater, in a proportion of 5.1 g/m² to one of the faces of a sheet of base paper having a grammage of 325 g/m² sold under the reference Optima P by the Applicant Company.

The coating composition comprises:
80 parts of magnesium fluorosilicate, sold by ROCKWOOD under the reference Laponite JS,
20 parts of an amorphous silica, sold by GRACE DAVISON under the reference Syloid 74C, having an oil-absorption capacity of 200 g/100 g of pigment,
10 parts of a vinyl acetate-ethylene copolymer binder, sold by VINAMUL under the reference Vinamul 3252.

### Example 8

A coating composition comprising a conductive synthetic pigment of magnesium fluorosilicate type and a pigment of amorphous silica type is applied, using an air knife coater, in a proportion of 5.1 g/m² to one of the faces of a sheet of base paper having a grammage of 325 g/m² sold under the reference Optima P by the Applicant Company.

The coating composition comprises:
90 parts of magnesium fluorosilicate, sold by ROCKWOOD under the reference Laponite JS,
10 parts of an amorphous silica, sold by GRACE DAVISON under the reference Syloid 74C, having an oil-absorption capacity of 200 g/100 g of pigment,
10 parts of a vinyl acetate-ethylene copolymer binder, sold by VINAMUL under the reference Vinamul 3252.

### Example 9

A coating composition comprising a conductive synthetic pigment of magnesium fluorosilicate type and a pigment of calcium carbonate type is applied, using an air knife coater, in a proportion of 5.2 g/m² to one of the faces of a sheet of base paper having a grammage of 325 g/m² sold under the reference Optima P by the Applicant Company.

The coating composition comprises:
60 parts of magnesium fluorosilicate, sold by ROCKWOOD under the reference Laponite JS,
40 parts of a calcium carbonate, sold by OMYA under the reference Hydrocarb 90 OG,
10 parts of a vinyl acetate-ethylene copolymer binder, sold by VINAMUL under the reference Vinamul 3301.

### Example 10

A coating composition comprising a conductive synthetic pigment of magnesium fluorosilicate type, a pigment of calcium carbonate type and a pigment of the silica type is applied, using an air knife coater, in a proportion of 5.5 g/m² to one of the faces of a sheet of base paper having a grammage of 325 g/m² sold under the reference Optima P by the Applicant company.

The coating composition comprises:
50 parts of magnesium fluorosilicate, sold by ROCKWOOD under the reference Laponite JS,
40 parts of calcium carbonate, sold by OMYA under the reference Hydrocarb 90 OG,
10 parts of an amorphous silica, sold by GRACE DAVISON under the reference Syloid 74C, having an oil-absorption capacity of 200 g/100 g of pigment,
10 parts of a vinyl acetate-ethylene copolymer binder, sold by VINAMUL under the reference Vinamul 3301.

### Example 11

A coating composition comprising a conductive synthetic pigment of magnesium fluorosilicate type, a pigment of calcium carbonate type and a pigment of the silica type is applied, using an air knife coater, in a proportion of 5.5 g/m² to one of the faces of a sheet of base paper having a grammage of 325 g/m² sold under the reference Optima P by the Applicant company.

The coating composition comprises:
15 parts of magnesium fluorosilicate, sold by ROCKWOOD under the reference Laponite JS,
80 parts of calcium carbonate, sold by OMYA under the reference Hydrocarb 90 OG,
5 parts of an amorphous silica, sold by GRACE DAVISON under the reference Syloid 74C, having an oil-absorption capacity of 200 g/100 g of pigment,
10 parts of a vinyl acetate-ethylene copolymer binder, sold by VINAMUL under the reference Vinamul 3301.

### Example 12

A coating composition comprising a conductive synthetic pigment of magnesium fluorosilicate type, a pigment of calcium carbonate type and a pigment of the silica type is applied, using an air knife coater, in a proportion of 4.8 g/m² to one of the faces of a sheet of base paper having a grammage of 325 g/m² sold under the reference Optima P by the Applicant company.

The coating composition comprises:
55 parts of magnesium fluorosilicate, sold by ROCKWOOD under the reference Laponite JS,
40 parts of calcium carbonate, sold by OMYA under the reference Hydrocarb 90 OG,
5 parts of an amorphous silica, sold by GRACE DAVISON under the reference Syloid 74C, having an oil-absorption capacity of 200 g/100 g of pigment,
10 parts of a vinyl acetate-ethylene copolymer binder, sold by VINAMUL under the reference Vinamul 3301.

### Example 13

A coating composition comprising a conductive synthetic pigment of magnesium fluorosilicate type, a pigment of calcium carbonate type and a pigment of the silica type is applied, using an air knife coater, in a proportion of 4 g/m² to one of the faces of a sheet of base paper having a grammage of 325 g/m² sold under the reference Optima P by the Applicant company.

The coating composition comprises:
67 parts of magnesium fluorosilicate, sold by ROCKWOOD under the reference Laponite JS,
29.5 parts of calcium carbonate, sold by OMYA under the reference Hydrocarb 90 OG,
3.5 parts of an amorphous silica, sold by GRACE DAVISON under the reference Syloid 74C, having an oil-absorption capacity of 200 g/100 g of pigment,
24 parts of a vinyl acetate-ethylene copolymer binder, sold by VINAMUL under the reference Vinamul 3301.

For each of the examples presented above, the Applicant carried out a number of tests which make it possible to assess in particular the electrical conductivity and the printability of the paper obtained.

Implementation of the Tests:

The surface electrical resistivity of the paper is measured in ohms using United States standard ASTM D257-99 at various relative humidities.
The drying capacity of the ink of the paper is determined by carrying out the offsetting test. The offsetting test is carried out in the following way:
a) test specimens of the paper to be tested are prepared with a width of 48 mm and a length of 250 mm
b) a Prüfbau testing device having a printing station No. 1 and a print transfer station No. 2 are used
c) the pressure of station No. 1 is adjusted to 1000 N and the pressure of station No. 2 is adjusted to 400 N
d) the speed of the device is adjusted to 0.5 m/sec
e) the inking roller of station No. 1 is inked for 30 sec with a blue ink of Huber 408010 type, the amount of ink on the inker being 0.25 cm³
f) a conveyor equipped with a test specimen is placed in front of post No. 1
g) an uninked roll is placed on station No. 2
h) the test specimen is printed on station No. 1
i) the stopwatch is started immediately after printing
j) a test specimen of the same paper is placed on the virgin roll of station No. 2 using an adhesive tape
k) once 15 sec have passed on the stopwatch, the conveyor equipped with the printed test specimen is advanced to the blanket
l) the test specimen of station No. 2 is immediately separated from its roll
m) the optical density of the cyan transferred onto the virgin test specimen is measured using an Xrite densitometer
n) the operations of stages f) to m) are repeated while respectively changing the time in stage k) to 30, 60 and 120 sec.
   The pick resistance of the paper is determined by carrying out an IGT pick test.

The IGT pick test is carried out in the following way:
a) the paper is cut in the transverse direction into strips with a length of 280 mm and a width of 25 mm
b) said strips are printed using an IGT device using a medium-tack ink supplied by COATES LORILLEUX under the reference 3804, the printing speed being varied from 0 to 7 m/sec
c) the speed starting from which picking occurs is recorded
d) the amount of paper particles present on the printing roll of the IGT device and the picking dots visible on the paper are observed.
   The ability of the conductive coating of the paper to correctly transmit information to a computer via an electronic pen is evaluated. This ability is obviously related to the conductibility specific to it. This test is carried out in the following way:
a) a transparent insulating varnish which can treated with ultraviolet radiation and which is supplied by VALSPAR (France) is printed on the paper, so as to form an insulating pattern in the form of a bar code above the conductive coating, the bar code being representative of a number in the binary form, the insulating parts being read as values of 0 and the conductive parts being read as values of 1
b) this bar code is scanned using the electronic pen represented in FIG. 1, the reader making sure that his other hand holds the paper on which the bar code is printed
c) as the pen is connected to a computer, the binary information read is converted to a decimal number by the computer and displayed on a control monitor
d) the information displayed is compared with the original information
e) if the information displayed is different from the original information or nonexistent, the paper is regarded as insufficiently conductive.

As this test does not involve an electronic pen currently available to the public, it is appropriate to define it with reference to FIG. 1.

A possible tubular configuration of this electronic pen (30) is represented diagrammatically in FIG. 1.

It is composed of an electrode in the form of a point (22) and of a second electrode (24).

The electrode (22) is configured so as to provide a flat circular contact with a diameter of approximately 1 mm. It is placed under tension using a spring while not exceeding a maximum tension of 0.1 N, so as not to damage the surface of the medium.

The second electrode (24) is composed of the tubular aluminum body of the pen (30).

Thus, when the pen (30) is used, the hand of the operator comes into contact with the external surface of the pen and thereby with the electrode (24) and completes the electrical circuit formed between the conductive medium and the pointed electrode (22).

An energy source, not represented in FIG. 1, is positioned so as to apply a voltage of 6 volts through the electrodes (22, 24).

The measuring device comprises a preamplifier (31) and a voltage oscillator/transducer (32). The high input impedance preamplifier (31) produces a 50-fold increase in current at the input terminal of the oscillator (32).

The input value of the oscillator (32) varies according to whether the electrode (22) is or is not in contact with a conductive part of the medium, that is to say according to whether there does or does not exist an electrical circuit between the two electrodes.

A variation in the input of the oscillator (32) produces a variation in the frequency of the output signal, and this change of frequency is used to detect that the electrode (22) has been brought into contact with a conductive or insulating region of the medium.

In the examples which follow, the oscillator (32) has been configured so that an output with a frequency of 11 kHz is produced when the electrode (22) is brought into contact with a conductive part of the medium and so that an output with a frequency of 4 kHz is produced when the electrode (22) is brought into contact with an insulating part.

The signal originating from the oscillator (32) subsequently flows into a coaxial cable (35) with a small diameter terminated by a plug (36), this plug being inserted into an input terminal of a computer so as to make possible the storage and the analysis of the input signal by said computer.

Results:

The results of the tests for examples 1 to 13 are presented in table 1.

For the test of the pen, “Yes” corresponds to correct reading and correct transmission of the information to the computer and “No” corresponds to absence of reading or completely erroneous reading of the information written on the paper.

“In part”, indicates random reading of the information.

It is found that, in the case of comparative example 1, the coated paper conventionally used for offset printing exhibits a high electrical resistivity and thus a low electrical conductivity.

The test of the pen confirms that the coating does not transmit information due to this low conductivity.

The following tests will allow it to be concluded that a paper having an electrical resistivity of greater than 10¹⁰ ohms at a relative humidity of 10% will be regarded negatively during the test of the pen.

In contrast, in comparative example 2, which corresponds to the conductive coating comprising a conductive pigment but no pigment which improves the printability, a low resistivity and thus a high conductivity is found.

The test of the pen is therefore positive.

However, the printability tests are poor.

The optical density during the offsetting test is greater than 0.8, after drying for 15 sec, which must be regarded as inadequate for offset printing of acceptable quality.

In examples 3 to 6, a variable level of coating pigment conventionally used to improve the printability, namely kaolin and calcium carbonate, was added to the conductive coating of example 2.

It is found, first, that a level of less than 20 parts of conductive pigment does not make it possible to have an acceptable electrical conductivity.

On reducing the amount of coating pigment, a better conductivity is observed but at the expense of the printability, which has to be regarded as inadequate.

In examples 7 and 8, a variable level of amorphous silica, possessing a better oil absorption level than the kaolin and the calcium carbonate, was added to the conductive coating of example 2.

A substantial fall in the drying time of the ink and a marked improvement in the electrical conductivity are observed in comparison with the preceding examples.

However, the paper undergoes not insignificant picking during printing, which may be troublesome for quality offset printing.

In Examples 10 to 13, the Applicant thus used a level of amorphous silica in the coating of less than 10 parts by dry weight and preferably of less than 5 parts by dry weight, in order to avoid these dusting phenomena, and compensated by a variable level of calcium carbonate.

It is found that, in comparison with example 9, where only calcium carbonate was used, the results of the offsetting tests are markedly better.

It is in fact confirmed, in example 11, that a level of magnesium fluorosilicate of less than 20 parts by dry weight results in an unacceptable electrical conductivity.

An improvement in the results in the pick test, in comparison with those of examples 7 and 8, is also found.

Finally, an ideal proportion of pigment in the coating which makes it possible to obtain good electrical conductivity of the coating while providing acceptable printability for the paper can be deduced therefrom.

This proportion was evaluated, in the light of the examples presented above and of others not provided in the present description so as to observe the conciseness required by legal texts, at a coating comprising from 60 to 80 parts of magnesium fluorosilicate, from 20 to 40 parts of calcium carbonate and from 2 to 5 parts of amorphous silica.

TABLE 1

| | Resistivity (in ohms) | | | Offsetting | | | | Picking | | |
|---|---|---|---|---|---|---|---|---|---|---|
| Example | 10% | 50% | 75% | (OD measured) | | | | Roller | Paper | Pen |
| No. | RH | RH | RH | 15″ | 30″ | 60″ | 120″ | dusting | picking | test |
| 1 | 2.4^{E}+11 | 1.3^{E}+11 | 2.0^{E}+9 | 0.59 | 0.35 | 0.20 | 0.16 | Very | Very | No |
| | | | | | | | | light | light | |
| 2 | 2.1^{E}+9 | 5.4^{E}+8 | 3.4^{E}+7 | 1.16 | 1.31 | 1.17 | 1.13 | Light | Light | Yes |
| 3 | 6.7^{E}+8 | 7.0^{E}+7 | 1.2^{E}+7 | 1.0 | 0.97 | 0.96 | 0.96 | Moderate | Very | Yes |
| | | | | | | | | | light | |
| 4 | 5.3^{E}+9 | 6.8^{E}+8 | 3.5^{E}+7 | 1.2 | 1.1 | 1.0 | 0.8 | Light/ | A few | In |
| | | | | | | | | moderate | dots | part |
| 5 | 9.7^{E}+8 | 1.6^{E}+8 | 1.1^{E}+7 | 1.17 | 1.16 | 1.1 | 0.87 | Light/ | A few | Yes |
| | | | | | | | | moderate | dots | |
| 6 | 3.6^{E}+10 | 4.7^{E}+9 | 2.1^{E}+8 | 0.99 | 0.83 | 0.54 | 0.20 | Light | 2-3 | No |
| | | | | | | | | | dots | |
| 7 | 5.8^{E}+8 | 6.2^{E}+7 | 5.5^{E}+6 | 0.21 | 0.18 | 0.15 | 0.12 | Moderate | A few | Yes |
| | | | | | | | | | dots | |
| 8 | 3.6^{E}+8 | 3.5^{E}+7 | 4.7^{E}+6 | 0.31 | 0.25 | 0.21 | 0.18 | High | A few | Yes |
| | | | | | | | | | dots | |
| 9 | 1.7^{E}+9 | 2.1^{E}+8 | 1.5^{E}+7 | 1.17 | 1.12 | 1.12 | 1.1 | Light/ | 1 dot | Yes |
| | | | | | | | | moderate | | |
| 10 | 7.4^{E}+9 | 6.7^{E}+8 | 3.2^{E}+7 | 0.2 | 0.16 | 0.14 | 0.11 | Light/ | A few | Yes |
| | | | | | | | | moderate | dots | |
| 11 | Infinite | 7.4^{E}+10 | 4.4^{E}+8 | 0.31 | 0.19 | 0.14 | 0.11 | Light/ | A few | No |
| | | | | | | | | moderate | dots | |
| 12 | 4.1^{E}+9 | 4.7^{E}+8 | 2.1^{E}+7 | 0.65 | 0.52 | 0.48 | 0.38 | Light/ | A few | Yes |
| | | | | | | | | moderate | dots | |
| 13 | 2.6^{E}+9 | 1.0^{E}+8 | 2.6^{E}+7 | 0.74 | 0.74 | 0.66 | 0.64 | Light | 1-2 | Yes |
| | | | | | | | | | dots | |

1. A print medium covered with an electrically conductive coating, characterized in that the conductive coating comprises at least one electrically conductive synthetic pigment and at least one coating pigment having an oil-absorption capacity of greater than 80 g/100 g of pigment as measured using the United States standard ASTM Standards D2414.

2. The print medium as claimed in claim 1, characterized in that conductive synthetic pigment is a magnesium fluorosilicate.

3. The print medium as claimed in claim 1, characterized in that the coating pigment is an amorphous silica.

4. The print medium as claimed in claim 3, characterized in that the amorphous silica has an oil-absorption capacity of approximately 200 g/100 g of pigment as measured using the United States standard ASTM Standards D2414.

5. The print medium as claimed in claim 1, characterized in that the conductive coating comprises a mixture of magnesium fluorosilicate, of amorphous silica and of calcium carbonate.

6. The print medium as claimed in claim 5, characterized in that the coating comprises a mixture of 20 to 100 parts by dry weight of magnesium fluorosilicate, of 0 to 80 parts by dry weight of calcium carbonate and of 0 to 10 parts by dry weight of amorphous silica and advantageously of 60 to 80 parts by dry weight of magnesium fluorosilicate, of 20 to 40 parts by dry weight of calcium carbonate and of 2 to 5 parts by dry weight of amorphous silica.

7. The print medium as claimed in claim 1, characterized in that it has an optical density of less than 0.8, an optical density determined using the Prüfbau print test and for a drying time of 15 seconds.

8. The print medium as claimed in claim 1, characterized in that it has a surface resistivity of less than 10¹⁰ ohms, the resistivity determined using the United States standard ASTM D257-99 and for a relative humidity of 10%.

9. The print medium as claimed in claim 1, characterized in that it comprises information in the form of an insulating pattern deposited on the conductive coating.

10. The print medium as claimed in claim 9, characterized in that the insulating pattern defines, in combination with the underlying conductive coating, a bar code in which the bars have variable widths and are alternately conductive and insulating.

11. The print medium as claimed in claim 1, characterized in that it comprises information read using a device sensitive to variations in electrical conductivity and subsequently transmitted to a computer for storage thereof and optional processing thereof.

12. A playing card comprising a print medium as claimed in claim 1.

13. The print medium as claimed in claim 2, characterized in that the coating pigment is an amorphous silica.
